(19) United States
(12) Patent Application Publication
(10) Pub. No.: US 2017/0331741 A1
(43) Pub. Date: Nov. 16, 2017

(54) MAC CHAINING LOAD BALANCER

(71) Applicant: Hewlett Packard Enterprise Development LP, Houston, TX (US)

(72) Inventors: Donald Fedyk, Littleton, MA (US); Paul Allen Bottorff, Roseville, CA (US)

(21) Appl. No.: 15/152,402

(22) Filed: May 11, 2016

(51) Int. Cl. H04L 12/803; H04L 12/741; H04L 12/46; G06F 9/455; H04L 29/12

(52) U.S. Cl. CPC H04L 47/125; H04L 61/6022; H04L 45/745; G06F 9/45545; H04L 12/4641; G06F 9/45558; G06F 2009/45595

(57) ABSTRACT

An example device in accordance with an aspect of the present disclosure includes identifying a service and/or management function among multiple functions based on an available capacity. Tables are updated to cause the packet to be forwarded to the identified function accordingly.

### BACKGROUND

Service functions are those services provided by a provider to process a data packet. These service functions may be performed on the data packet between networking components. As such, these service functions may provide an enhancement to network operations and/or provide additional services.

### BRIEF DESCRIPTION OF THE DRAWINGS/FIGURES

FIG. 1 is a block diagram of an example networking system including a networking component to receive a packet and for a load balancer to identify a function among management and service functions to receive the packet;

FIG. 2A illustrates an example networking system including various locations of a load balancer for identification of a service and/or management function path, and/or identification of a service and/or management function instance;

FIG. 2B is a diagram of an example database of a received packet and various modifications to a destination address to correspond to various identified service and/or management function instances;

FIG. 2C is a diagram of an example database of a received packet and various modifications to a destination address and/or source address to correspond to various identified service and/or management function paths;

FIG. 3 is a block diagram of an example networking system including a service function forwarder, a load balancer, and a port multiplexer in the context of media access control (MAC) chaining;

FIG. 4 is a flow diagram illustrating packet handling in the context of MAC chaining;

FIG. 5 is a flowchart of an example method executable by a networking device to modify tables of packet signature addresses.

### DETAILED DESCRIPTION

The service functions are those services, processes, operations, and/or functions which may be administered by a provider to add value to packet transportation and processing. Other service functions may operate as a final destination in a networking system. For example, the service functions may include those services which add value, control quality of service, enhance privacy, and/or provide internal tracking mechanisms. Examples of the service function may include deep packet inspection (DPI), firewalls, tracking packet sizes, encryption/decryption, latency improvements, improvements in resolving addresses, improvements in transferring information to cover packet losses, network address translation, post-identification inspection, network forwarding policy, layer four-layer seven (L4-L7) switching, multiprotocol label switching (MPLS), virtual local area network (VLAN) switching, meta-data switching, hypertext transfer protocol (HTTP) enhancement, data caching, accounting, parental controls, call blocking, call forwarding, etc. The deployment of these service functions are based on the ability to create a service function path and/or pipeline to instances of these service functions for the traffic to flow through to these service functions. As referred to throughout this document, the term service function instance is the individualized service function while the term service function path includes a series of these service function instances to be performed on a given packet during transportation.

Service functions are implemented using a variety of techniques. One technique is based on a hard wired static network configuration. When using this method changes in the service function locations are very costly since they require physically re-wiring the network. Other methods have been proposed to solve the problems caused by hard wired configurations which use proprietary switching formats, tunneling, packet flow policy switching, etc. This results in a highly complex system and service functions may become incompatible with existing infrastructure within a network. For example, the service function may use newer protocol formats which may be impractical on existing infrastructure. Additionally, a packet may be modified to route to particular service function, but this may cause issues as the more the packet is changed, these changes may affect other networking aspects. For example, modifications to layers three through layers seven (L3-L7) may become complicated because packet modifications may cause further issues down the line in transporting the packet within the network.

Further, if a service function processes a high number of packets, this may create a bottleneck resulting in congestion. If the congestion occurs over a long enough period of time, this may lead to packet loss. Splitting the packet load over redundant service functions may be inefficient as the available capacity of the service functions are not taken into consideration.

To address these issues, some examples disclosed herein provide a mechanism to enable load balancing across service functions and/or management functions in existing infrastructure, in the context of Service Function Forwarders (SFFs) and/or load balancers for media access control (MAC) chaining. Examples include a load balancer to identify a service function and/or management function among multiple functions based on a capacity available at each of the service and/or management functions. The available capacity is the amount of resources for example bandwidth, CPU capacity, memory etc., at each function which is free to perform packet processing. Taking into consideration the available capacity at each function, the load balancer can efficiently distribute packets to the appropriate function.

Example functions include control plane functions such as MAC filter table trace, and data plane functions such as chain segment/branch tracing and continuity tests, MAC frame statistics, forwarded frames (MAC signature), dropped frames (MAC signature), delay measurements, load measurement feedback, and the like. Pre-provisioning management functions can check the operation of the service function chain (SFC) before live traffic is placed on the SFC. Tracing can be used to determine all the paths in the chain, including complex chains having branches and multiple paths, where example management frames enable testing of all paths (in contrast to relying on data that may not exercise all paths in a chain). Failure detection management functions enable isolation of the failure inside the network, and identifying where the chain is broken. Failure detection can be based on a continuity check message, whereby failure is detected by the loss of a continuity check message. Failure detection can also be used to raise a notice of the failure through a management plane, thereby flagging the failure for management to handle.

Upon identifying the service and/or management function(s), the load balancer modifies the signature address in the packet to correspond to the identified service function and/or management function. Modifying the signature address, a networking component distributes the packet to the identified service function and/or management function. Modifications to the signature address provide compatibility of service function chaining on existing infrastructure in the context of MAC chaining. For example, when packets egress from the networking component, these packets with the signature address modifications are considered standard network frames without format change(s). Additionally, modifying the signature address provides the ability to insert and delete service function(s) and/or management function(s) with ease. This provides an additional level of control over the service function(s) and/or management function(s) performed on a given packet.

In another example discussed herein, the modified signature address is modified within a layer two (L2) portion of the packet and as such may further include modifying a media access control (MAC) address. Modifying the L2 portion of the packet provides less risk as the modifications to the L2 portion is less likely to affect other networking aspects. Also, modifications to the MAC address enables the compatibility of the service functions on existing infrastructure.

Examples disclosed herein provide a mechanism in which a service function chain may be compatible on existing infrastructure. Additionally, the examples enable a flexibility for routing the packet to a particular service function and/or management function. Furthermore, examples disclosed herein enable the realization of MAC chaining in a virtual machine. The virtual machine can be implemented in a computer with memory, such as a server or a server card in equipment. A Service Function Forwarder (SFF) for MAC chaining can perform many operations in software (a function or process written in software), such as: looking up a MAC Chaining destination address (DA), looking up a MAC Chaining DA and source address (SA) together, adding a MAC chaining header (which may be a single header based on lookup or a load balanced header based on lookup), removing a MAC chaining header, maintaining tables for forwarding lookup, recognizing management frames, performing extra functions based on the management frame context, performing proxy functions, storing a packet context, converting a packet to standard form, converting a packet to MAC chain format, sending packets to service function(s), and so on. Accordingly, examples implementations described here can receive a packet including a signature address, and use a filter table for Media Access Control (MAC) chaining to identify corresponding service function chains. A load balancer identifies at least one of i) a service function instance among a plurality of service function instances, and ii) a management function instance among a plurality of management function instances, for packet distribution among the plurality of corresponding functions based on an available capacity of the corresponding functions.

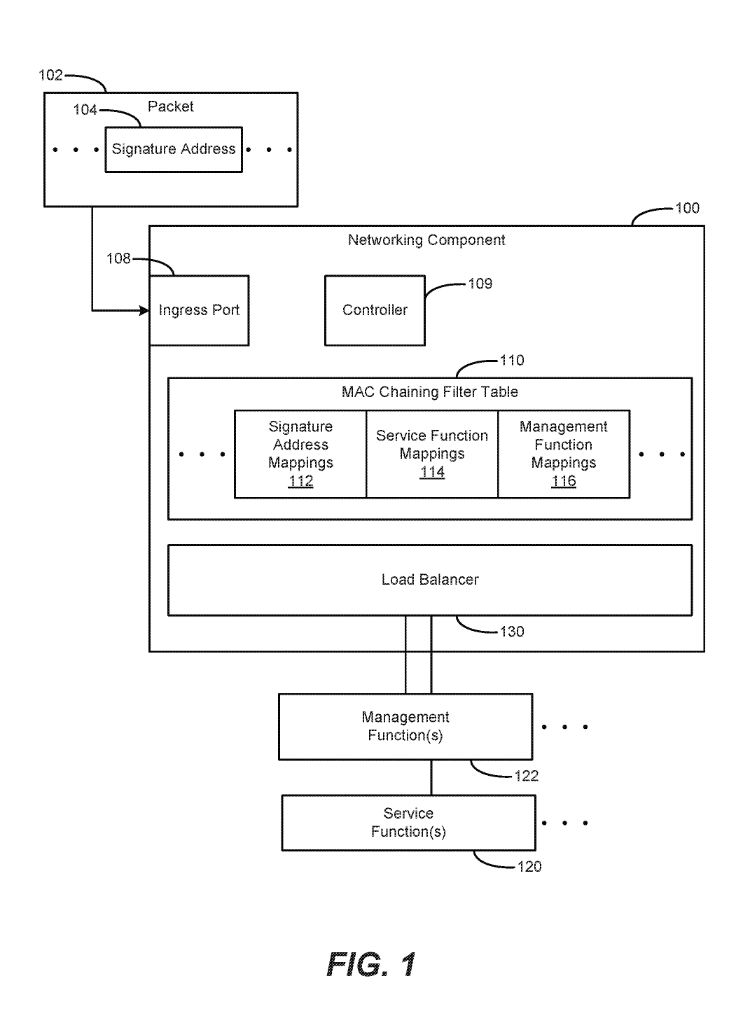

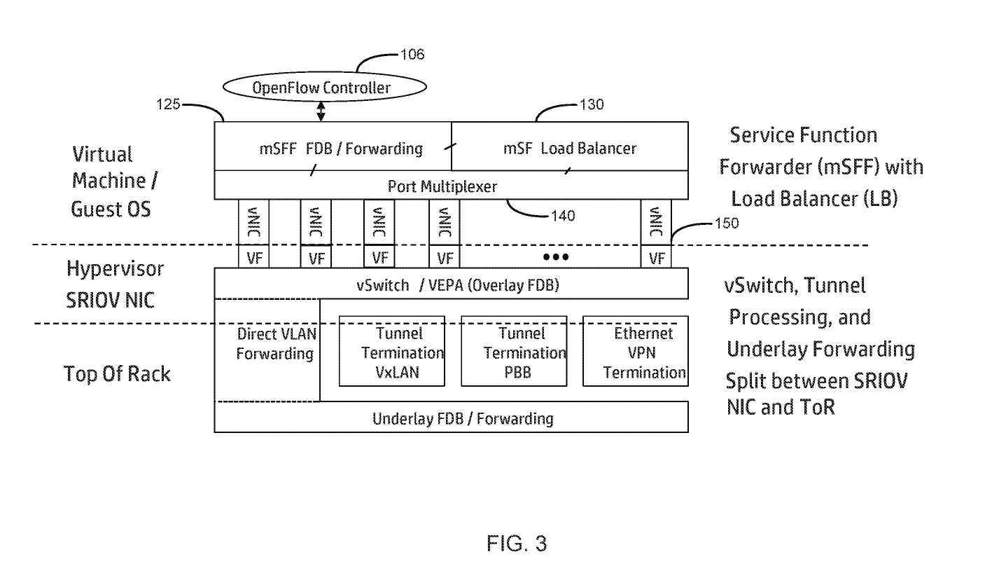

Referring now to the figures, FIG. 1 is a block diagram of an example networking system including a networking component 100 to receive traffic in the form of a packet 102. The packet 102 includes a signature address 104. The networking component 100 uses the filter table 110 in Media Access Control (MAC) chaining, to contain mappings between signature addresses 112, service functions 114, and management functions 116. The controller 109 can uniquely identify a management function 122 corresponding to the signature address 104 of the packet 102, and modify tables of packet signature addresses usable to modify the packet 102 to cause the packet 102 to be forwarded, via the load balancer 130, to the corresponding management function 122. The controller 109 can be a management agent, which can work in conjunction with a service chaining controller (such as an OpenFlow controller, see element 106 of FIG. 3). In an example implementation, the controller 109 can share overlapping responsibilities with the service chaining controller. Functions of the management agent also can be provided locally by service chain forwarder function (SFF) tables, in addition to the service chaining controller's functions. Additionally, although the controller 109 is illustrated as a single component, aspects of programming, management, tracing, and other operations can be provided independently/remotely, and/or passed to a central controller (such as a central processing unit (CPU)).

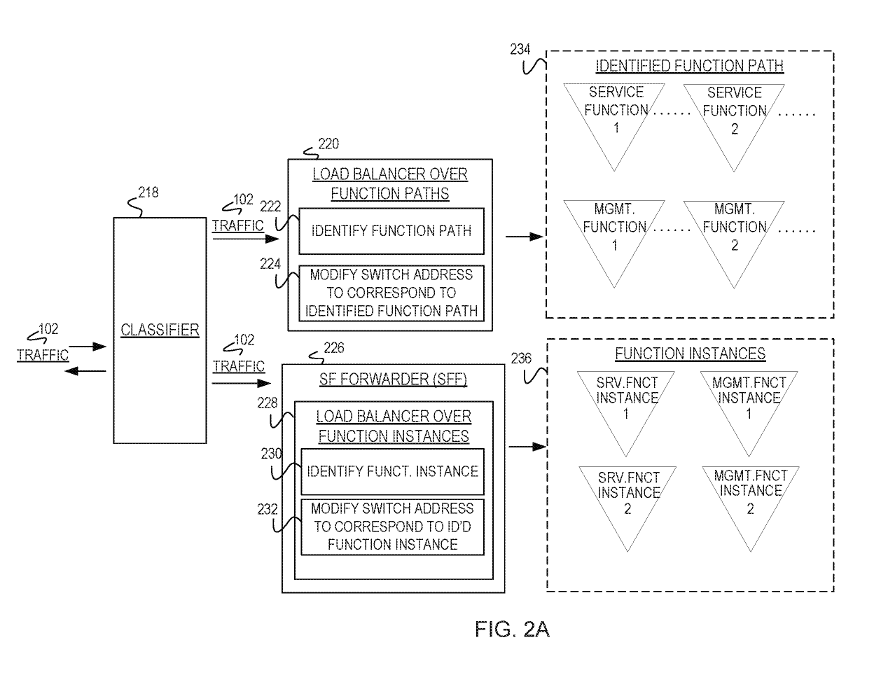

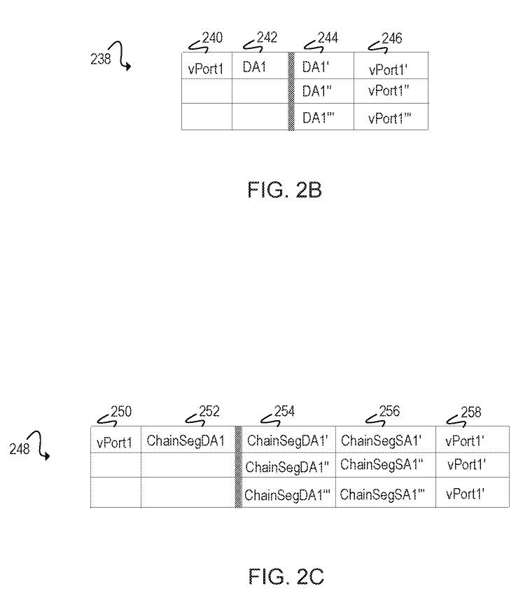

The networking component 100 transmits the packet 102 to a load balancer 130. The load balancer 130 proceeds to identify a management function(s) 122 and/or service function(s) 120 among multiple functions 120, 122. Upon identifying the corresponding management and/or service function(s), the load balancer 130 proceeds to modify the signature address 104 in the packet 102 to produce a modified signature address indicating a location for the networking component 100 to forward the packet 102 accordingly. As such, the modified signature address corresponds to the identified service and/or management function(s). The correspondence allows the networking component 100 to appropriately route the packet 102 to the service function(s) and/or management function(s) that have the capacity to handle the traffic (e.g., the packet 102), based on balancing the loads between the various functions. The management function(s) 122 and/or service functions 120 may include those service functions a networking carrier may wish to perform upon the packet 102 when routing between computer nodes in the networking system. As such, each management function(s) 122 and/or service function(s) 120 can include a different address indicating the location of where to route the packet 102. In one implementation, the management function(s) 122 and/or service functions 120 are each a different corresponding management and/or service function instance. The management and/or service function instances are considered individual service function events which may be performed on the packet 102. The load balancer 130 can be located between a service function forwarder (SFF) and each management and/or service function instance. Thus, when the management and/or service function instance is performed, the packet 102 is routed back to a SFF for the appropriate distribution. In another implementation, the management function(s) 122 and/or service function(s) 120 each include a different service function path. A given service function path is a series of service function and/or management function instance. The load balancer 130 can be located between an ingress classifier (not illustrated in FIG. 1, see FIG. 2) and each of the service/management function paths in which to distribute the traffic. The networking system as illustrated in FIG. 1 represents a data network in which networked computing devices (e.g., networking components) may exchange traffic (e.g., packets). These networked computing devices establish data connections in the form of networking links between nodes to route and/or forward traffic. Implementations of the networking system include, by way of example, a telecommunications network, Internet, Ethernet, wide area network (WAN), local area network (LAN), optic cable network, virtual network or other type of networking system which passes traffic between nodes.

The networking component 100 is the networked computing device which may establish the data connection with other networking components and/or forward the packet 102 accordingly. As such, the networking component 100 receives the packet 102 and transmits to the load balancer 130. Implementations of the networking component 100 include a multi-port network device, multi-layer switch, media access control (MAC) switch, router, virtual switch, virtual controller, or other type of networking component capable of receiving the packet 102 for transmission to other networking components.

The traffic as illustrated by the packet 102, is received by the networking component 100 to identify the signature address 104. In one implementation, an ingress classifier (not illustrated) receives the packet 102 and transmits to the load balancer 130. The load balancer 130 in turn modifies the signature address 104 from the packet 102 to produce the modified signature address 114. Although the traffic is illustrated as a single packet 102, this was done for illustration purposes as the traffic may include multiple packets. As such, the packet 102 is considered a networking packet or data frame which is a formatted unit of data carried by the networking system. For example, the data packet 102 or data frame consists of wire formats for standardizing portions of the packet 102. Accordingly, the packet 102 consists of at least two kinds of data including network control information and user data (i.e., the payload). As such, the control information may further include the signature address 104. The control information provides data for the networking system to deliver the payload to the appropriate destination. For example, the control information may be part of an open systems interconnection (OSI) model and as such may include the data that characterizes and standardizes the internal communication functions by partitioning the network control into various abstract layers, such as layers one through layers seven (L1-L7). This control information may be found within the headers and/or trailers. In this example, the signature address 104 would be considered part of the layer two (L2) portion of the packet 102.

The signature address 104 is a unique identifier assigned within the packet 102 for communications on a physical networking segment. Upon receiving the packet 102 with the signature address 104, the load balancer 130 identifies which of the service and/or management functions 120, 122 has the capability of available resources to handle the packet 102. Upon identifying the service and/or management function to handle the packet 102, the signature address 104 is changed to a modified signature address to correspond to the identified service and/or management function. In one implementation, the signature address 104 is a media access control (MAC) address while in another implementation, the signature address 104 is part of the L2 portion of the packet 102.

The load balancer 130 receives traffic (e.g., packet 102) and in turn determines which service and/or management function 120, 122 in which to distribute the traffic. Upon determining which service and/or management function 120, 122 to distribute the traffic, the load balancer 130 proceeds to implement the modified signature address to distribute the traffic to the appropriate service and/or management function. The load balancer 130 may include a type of load distribution engine and as such implementations may include, electronic circuitry (i.e., hardware) that implements the functionality of the load balancer 130. In this example, load balancer 130 may include by way of example, an integrated circuit, application integrated circuit (ASIC), controller, virtual controller, processor, semiconductor, processing resource, chipset, semiconductor, or other type of hardware or software implemented component capable of the functionality of the load balancer 130. Alternatively, the load balancer 130 may include instructions (e.g., stored on a machine-readable medium) that, when executed by a hardware component (e.g., processor and/or controller), implements the functionality of the load balancer 130.

The networking component 100 uses the signature address 104 to identify which service and/or management function 120, 122 to route the traffic based on the available capacity at each of the service and/or management functions 120, 122. Identifying the particular service and/or management function 120, 122 among the multiple service and/or management functions 120, 122 based on the available capacity is a mechanism in which to perform the load balancing of traffic. The networking component 100, namely the load balancer 130, identifies which of the service and/or management function(s) 120, 122 to distribute the traffic, accordingly. This decision can be based on, e.g., the available capacity at each of the service and/or management functions 120, 122. This available capacity may be determined through various techniques including, but not limited to: the available resources of one or more of the service and/or management functions 120, 122; feedback from one or more of the service and/or management functions 120, 122; reactively tracking which service and/or management function 120, 122 is the least loaded with traffic; predictively estimating how much traffic was sent at one or more of the service and/or management functions 120, 122; ordering a number of the service and/or management functions 120, 122; performing a weighted distribution on one or more of the service and/or management functions 120, 122; tracking which service and/or management function 120, 122 may be more efficient than others; and based on historical performance of one or more of the service and/or management functions 120, 122. Based on the identification of which service and/or management function 120, 122 to distribute the traffic, the load balancer 130 modifies the signature address 104 to obtain the modified signature address, to direct the location of the service and/or management function 120, 122 for performance.

In an example implementation, the networking component 100 can utilize the filter table 110 to locate identified service and/or management functions and the corresponding modified signature address, according to the various mappings 112, 114, 116. The filter table 110 may include various signature address mappings 112 (e.g., modified signature address(es)), and the corresponding mappings to service and/or management function(s) 114, 116. In an example implementation, the load balancer 130 modifies a media access control (MAC) address from the signature address mappings 112. For example, the load balancer 130 can modify a destination address (DA) and/or source address (SA) to achieve a modified destination address (DA′) and modified source address (SA′) (see FIGS. 2B, 2C). The various illustrated components may include, by way of example, electronic circuitry (i.e., hardware) and/or instructions (e.g., stored on a machine-readable medium) that, when executed (e.g., by the networking component 100), implement the described functionality.

The signature address mappings 112 represent addresses at which the identified service and/or management function(s) are located. Thus, the modified signature address mappings 112 can provide the location of where to distribute the traffic, accordingly. Upon identifying which service and/or management function 120, 122 to distribute the traffic, the networking component 100 proceeds to identify that address from the filter table 110 corresponding to the identified service and/or management function. As such, the networking component 100 proceeds to transform the signature address 104 using the filter table 110. Although the signature address mappings 112 can include both a modified destination address (DA′) and a modified source address (SA′), this was done for illustration purposes and implementations should not be limited. For example, the signature address mappings can include a modified destination address alone, or in addition, may also include the modified source address.

The service and/or management function(s) 120, 122 are those function instances or function paths as provided by the network carrier for processing traffic. A given service and/or management function 120, 122 can represent a different function path or different function instance. Thus, each different function can correspond to a different modified address. In one implementation, each service and/or management function 120, 122 is located at a different networking component, while in another implementation, each service and/or management function 120, 122 is implemented as a virtual function. Although FIG. 1 illustrates the service and management function(s) 120, 122 as separate from the networking component 100, this was done for illustration purposes as the service and/or management functions 120, 122 may be part of the networking component 100. In an example implementation, the system can prioritize processing MAC chaining headers, corresponding to service functions for the packet, over processing of management headers, corresponding to management functions for the packet. Thus, the networking component can check the packet for management headers of the packet that follow the MAC chaining headers of the packet, to avoid performance issues associated with management functions that might consume more processing resources compared to service functions. In an example, the filter table 110 can be implemented as a forwarding database, and the filter table 110 and the load balancer 130 can be built using OpenFlow.

FIG. 2A illustrates an example networking system including various locations of a load balancer 220 and 228 for identification of a function (SF) path 234 or identification of a function instance 236. The load balancers 220 and 228 illustrate the various implementations of whether the load balancer 220 or 228 is to distribute the traffic 102 to the identified function path 234 or the function instance(s) 236. In the case of the load balancer 220, the traffic 102 may be distributed over a set of service function paths. In the case of the load balancer 228, the traffic 102 may be distributed over a set of function instances. As explained earlier, the function path is a series of multiple service and/or management function instances while the service and management function instances are each individual service/management functions (e.g., DPI, firewall, etc.). Although FIG. 2A illustrates both load balancer cases 220 and 228, this was done for illustration purposes as the networking may also include the situation of either load balancer 220 or 228, or additional load balancers not specifically shown.

A classifier 218 receives traffic 102 and in turn may transmit the traffic to either the load balancer over the function paths 220 or to a service function forwarder (SFF) 226. The classifier 218 forms an initial encapsulation and may set the initial meta-data for each packet in the traffic 102. The route of the traffic 102 to either the load balancer over the function paths 220 or the load balancer over function instances 228 may be dependent on which load balancer is implemented in the networking system. For example, if the load balancer of the function paths 220 is implemented but not the load balancer of function instances 228, then traffic 102 is routed to the load balancer 220. At modules 222-224 and 230-232, each load balancer 220 and 228 proceeds to identify which function path or function instance for traffic distribution based upon the available capacity at each respective service or management function. Upon identifying the respective function path or function instance, the respective load balancer 220 or 228 modifies a signature address in the traffic 102 to correspond to the identified function path 234 or function instance 236. The identified function path 234 is the series of service and/or management function instances to process the traffic 102. Upon completion of identified function path 234, the networking component forwards the traffic 102 to the final destination. The identified function instance may include one of the service and/or management function instances 236 (service function instance 1, service function instance 2, management function instance 1, or management function instance 2), and as such, the traffic 102 may be routed to one of the function instances and back to the SFF 226 for forwarding to the final destination.

FIGS. 2B-2C illustrate example filter tables, e.g., databases 238 and 248, to modify a signature address in a packet, accordingly. These databases 238 and 248 may use the networking component to find the signature address for modification to correspond to the identified service and/or management function instance or service and/or management function path. For example, in the database 238 and 248, the signature addresses 242 and 252, for a single packet may include: DA1 and ChainSegDA1. Each of these signature addresses 242 and 252 illustrate a destination address as provided in the packet. Using the identified service and/or management function, the networking component determines a subsequent modified destination address 244 and 254 and also in addition a modified source address 256 and/or egress port 246 and 258. These egress ports 246 and 258 are connected to a virtual machine, virtual network, physical machine, and/or physical network for forwarding the packet(s) to the identified service and/or management functions. In further implementations, the databases 238 and 248 may include an entry specifying a direction of the various packets.

FIG. 2B is the database 238 for the load balancer 228 in FIG. 2A to distribute a packet to a set of various service and/or management function instances. In this figure, the database 238 includes the received packet from ports 240 (VPort1) and unmodified destination addresses 242 (DA1). Upon identification of the specific service and/or management function instance, the load balancer 228 modifies the destination address 242 in the packet to obtain the one of the modified destination addresses 244 (DA1′, DA1″, and DA1′″) which corresponds to the identified service and/or management function instance. Each of the modified destination address 244 represent a different service and/or management function instance. As such, the various address modifications are represented with a prime (′) symbol. In a further implementation, in addition to the destination modification address, the ports 240 are modified to obtain one of the various egress ports 246 (VPort1′, VPort1″, or VPort1′″). To distribute the packet to one of the various service and/or management function instances, the load balancer 228 implements the modified destination address 244 and modified port 246 while a source address may remain unchanged. The modified destination address 244 and modified port 246 each correspond to a different service and/or management function instance. For example, the DA1′ represents the service and/or management function instance which is different from the other service and/or management functions in DA″ and DA′″.

FIG. 2C is the database 248 for the load balancer 220 in FIG. 2A to distribute a packet to a set of various identified service and/or management function paths. In this figure, the database 248 includes a received packet with the port 250 (VPort1) and unmodified destination address 252 (ChainSegDA1). Upon identification of the service and/or management function path, the load balancer 220 modifies the destination address 252 in the packet to obtain one of the modified destination addresses 254 (ChainSegDA1′, ChainSegDA1″, and ChainSegDA1′″) which corresponds to the identified service and/or management function path. In a further implementation, in addition to the modified destination address, the load balancer may proceed to modify the source address 256 (ChainSegSA1′, ChainSegSA1″, and ChainSegSA1′″). In this implementation, the ports 258 may remain unmodified. The various chain segment destination addresses (ChainSegDA1′, ChainSegDA1″, and ChainSegDA1′″) represent one of the various service and/or management functions within each of the representative service function paths.

FIG. 3 is a block diagram of an example networking system including a service function forwarder 125, a load balancer 130, and a port multiplexer 140 in the context of media access control (MAC) chaining. The port multiplexer 140 is to forward packets, and can forward the packet based on MAC chaining, to enable multiplexing at a lowest software stack level. In an example implementation, a virtual port (vport) is mapped to a corresponding vNIC 150. Such mappings can be implemented in the filter table 110 (see FIG. 1). For example, mappings of the filter table can be based on an egress vport, such that the filter table includes mappings for a given packet between i) a key, a vport, and a destination MAC, and ii) a new destination MAC and vport. The filter table 125, load balancer 130, and port multiplexer 140 can be implemented as an application in a guest operating system (OS)/virtual machine. The system provides a control point based on using a control protocol such as OpenFlow, and can use OpenFlow to build a forwarding database 125. Full multi-table OpenFlow can be supported and used to program the forwarder 125 and the load balancer 130 together.

The system of FIG. 3 includes a virtual machine/Guest operating system (OS) interfacing with one or more virtual network interface controllers (vNICs) 150 via a port multiplexer 140. Thus, the system can be based on Direct Memory Access (DMA) for the packet/traffic, and can be implemented as a virtual machine associated with at least one virtual network interface controller (vNIC) 150. In alternate example implementations, the system can be based on message passing for the packet, and is associated with at least one mailbox serving as a delivery point for messages in the OS core. Connection into a guest OS enables the system to attach applications, as in a general computing environment. The forwarder 125 and load balancer 130 can be built as applications inside a general OS environment. The port multiplexer 140 is shown attached to myriad of vNICs 150, each of which that can represent a virtual port. The filtering table 125 can map/decode the virtual port and the destination MAC. The port multiplexer 140 can perform traffic selection on the way in and out from the FDB 125, and can perform load balancing (e.g., via load balancer 130) decisions to the destination virtual port. Accordingly, the vNICs 150 can be mapped based on MAC chaining, which can map directly to the vNIC 150. Although the port multiplexer 140 is shown interfacing with a plurality of vNICs 150, the port multiplexer 140 can also represent a single vNIC 150.

Implementing MAC chaining Service Function Forwarding (SFF) in software, as illustrated in FIG. 3, enables the ability to process and forward packets cost-effectively, and MAC chaining can use existing packet headers available in standard servers for off-the-shelf capability. The MAC SFF can be implemented as a software process. Packets are sent to a MAC address via a virtual Network Interface card (vNIC) 150 that determines the SFF process operations. vNICs 150 represent logical entities that multiplex the packets to and from the SFF forwarding data base (FDB) 125 lookup. In an example implementation, when a vNIC 150 receives a packet, the vNIC 150 can put the packet in memory and generate an interrupt to the system's controller/central processing unit (CPU). The CPU interrupt routine will deliver an indication to the SFF 125 and a pointer to the packet. The SFF process looks up the next operation based on the received port (vNIC) and MAC addresses in the packet. Thus, the system can map the vport to the vNIC, e.g., based on an egress vport in the forwarding table 125. MAC chaining can therefore be performed by mapping a double to a triple, e.g., by taking a key (the vport plus destination MAC), and mapping onto a new destination MAC, the source MAC, and vport. Such mappings can be embodied in the mappings 112, 114, 116 illustrated in the filter table 110 of FIG. 1.

A vport can represent an abstraction, and portions illustrated in FIG. 3 below the upper dotted line can be responsible for creating the mapping before traffic reaches the network, to encode the vport. Such encoding can vary, depending on the vport. FIG. 3 illustrates four example techniques among many, including Direct VLAN forwarding, Tunnel Termination VxLAN, Tunnel Termination PBB, and Ethernet VPN termination.

The described operations can be preprogrammed by a software controller and a local FDB update process, which may be the same as the SFF process. MAC addresses that do not match any forwarding entries may be passed on to exception handling software (other processes) for statistics or other operations. The operation may also be setup on demand by detecting a missing lookup. MAC chaining packets may be forwarded transparently through normal bridging operations until they reach an SFF process that owns the MAC DA in the header.

The SFF process of filter table 125 looks up either the MAC DA, or the MAC DA and SA together, to determine the next operation from the Forwarding Database. The FDB determines the next operation. In an example, the existing MAC chaining header is removed and another MAC chaining header is added, based on the FDB table operation. The new header may be to a single service and/or management function in the chain, or load balanced (via load balancer 130) to several parallel service and/or management functions in a chain, e.g., based on a load balancing distribution function. Load balancing distribution functions may use additional information in the packet or from the service/management functions to determine the next service/management function.

When the packet header is added, the SFF 125 forwards the packet out the vNIC 150 to the next destination. This may involve passing a pointer to the DMA logic and notifying the DMA to send the packet out the vNIC 150. The next destination may be a native Ethernet network or a virtual Ethernet network as provided by various tunnel technologies (VxLAN, PBB, Ethernet VPN etc.).

Often a SFF process forwards a packet to a service/management function that will return the packet back to the same SFF process. A special case is a proxy SFF process where the service/management function is MAC chaining unaware, and the SFF does the MAC chaining by proxy. In this case, the SFF process is to remember the context of the forwarded packet, to continue the forwarding on to another entity (service function, management function, SFF, or chain termination function) in the chain.

Management function processing is enabled by the SFF process being able to check the packet for management function headers that follow the MAC chaining headers. The check for a management frame allows the SFF process to trace and monitor the SFF data plane. Management functions may consume more processing resources than normal SFF functions, and therefore the SFF may delay the processing of management frames. By having the SFF process in software, the SFF can be placed anywhere, including being placed in computing resources that are co-located with the service and/or management functions themselves.

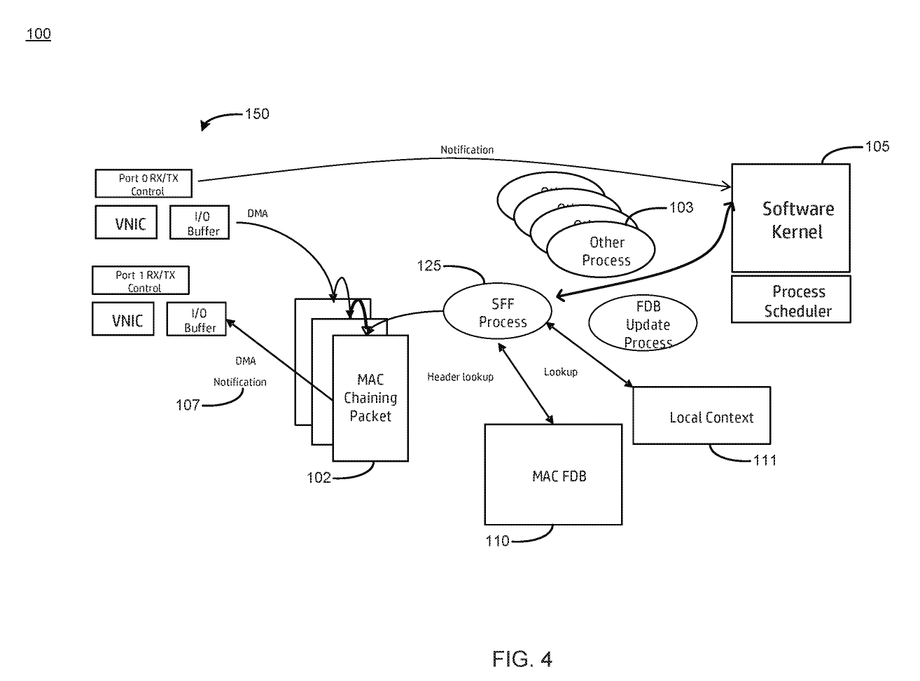

FIG. 4 is a flow diagram illustrating packet handling in the context of MAC chaining. A VNIC portion 150 of the system 100 is to DMA the packet 102 into memory for the guest OS, and the SFF process 125 is to perform chain forwarding. This results in modifying memory contents and a local context. The control path then provides a DMA notification 107 to the VNIC portion 150. A parallel event notification can be generated, as a packet 102 is arriving. The SFF process 125 can proceed in response to the notification(s). Event notifications can also be sent to the software kernel 105, which hands off to an application (e.g., the SFF process 125) that runs through the MAC FDB table 110 and local context 111, modifying as described above. Another notification can be provided to the software kernel 105 from the SFF process 125, to generate a DMA notification on outbound. System 100 can be provided in the context of an OS environment, whereby the vNIC portion 150 can be in control from the OS, the OS can be handling the transfer from VNIC 150 to memory, and transfers from the kernel 105 of the guest OS to the application. The SFF process 125 can be implemented as an application in the guest OS. The other processes 103 can include other applications that are running. In alternate example implementations of the system 100 that are implemented in a networking component (such as a switch), the other processes 103 can be omitted.

The VNIC portion 150 is optional. In alternate example implementations, such as a system passing information to a SFF process 125 that would be co-located in the same networking component/switch, the DMA operations can be avoided and message passing can be used instead. Thus, the DMA operations in FIG. 4 can be replaced with message passing using an actor environment. A message can come in from a message path from another process, and go back out. Thus, system 100 of FIG. 4 can use a message pass instead of an input/output (I/O) interface. In such a variation, the VNIC portion 150 can be represented instead by other types of components, such as a service access point (SAP), a message queue, or mailbox. The message queue can include a buffer. The mailbox can serve as a delivery point for messages in an OS core.

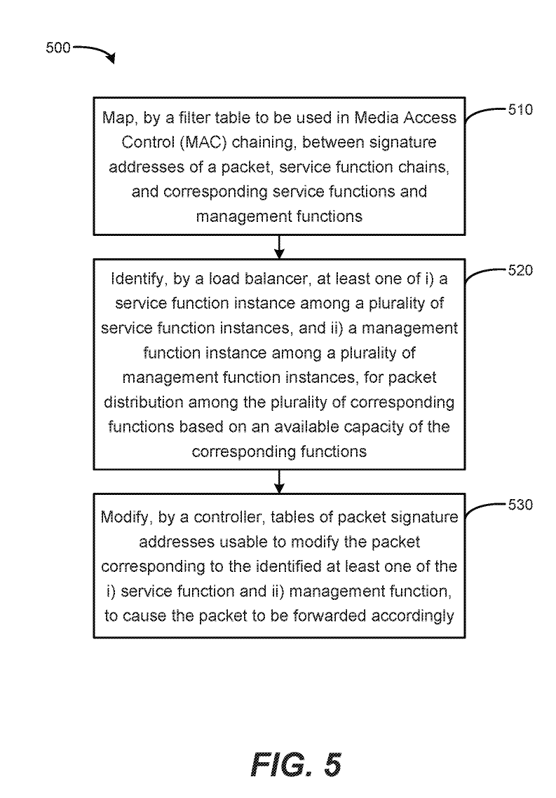

FIG. 5 is a flowchart of a method executable by a networking component to modify tables of packet signature addresses, e.g., from incoming traffic to distribute the traffic to an identified service function and/or management function path. The function path can be identified from among multiple service and/or management function paths based on an amount of available capacity of each of the paths. The amount of available capacity of a given path indicates to the networking component the amount of free resources space for processing the traffic. The greater the amount of available capacity, the more traffic that function path may handle. Initially, the networking component receives traffic in the form of data packet(s). These data packets include the signature address(es) and indicate to the networking device the computational load of the packet so the networking component may identify the appropriate service and/or management function path. The packet also can be identified as a user traffic packet, or a management packet for enabling various control and data plane functionality in the context of MAC chaining. The signature address may be found in the layer two (L2) portion of the packet. As such in this implementation, the packet may be formatted for compliance with IEEE 802® standards. In other implementations the packet is in a format such as an open systems interconnection model (OSI). Upon receiving the packet, the networking component distinguishes the signature address from other information (e.g., computation load of the packet and/or size of the packet, metadata, etc.) included in the packet. In discussing FIG. 5, references may be made to the components in FIGS. 1-4 to provide contextual examples. In one implementation, the networking component 100 as in FIG. 1 executes operations 510-530 to perform load balancing through the identification of corresponding service and/or management function chains. Further, although various techniques are described as implemented by the networking component 100, it may be executed on other suitable components, such as in the form of executable instructions on a machine-readable storage medium.

In block 510, a filter table to be used in Media Access Control (MAC) chaining, is to map between signature addresses of a packet, service function chains, and corresponding service functions and management functions. For example, the filter table includes a plurality of signature addresses 112 that a system can use to uniquely look up a given signature address 104 of a received packet, and map that address to a unique service function 120 and/or management function 122.

In block 520, a load balancer is to identify at least one of i) a service function instance among a plurality of service function instances, and ii) a management function instance among a plurality of management function instances. Such identifications enable packet distribution among the plurality of corresponding functions, based on an available capacity of the corresponding functions. For example, the system can identify available capacity using techniques including, but not limited to: the available resources of the functions; feedback from the functions; reactively tracking which function is the least loaded with traffic; predictively estimating how much traffic was sent at the functions; ordering of the functions; performing a weighted distribution on the functions; tracking which function may be more efficient; and based on historical performance of the functions.

In block 530, a controller is to modify tables of packet signature addresses usable to modify the packet corresponding to the identified at least one of the i) service function and ii) management function, to cause the packet to be forwarded accordingly. For example, a load balancer can modify a switch signature address in a packet to produce a modified signature address indicating a location to forward the packet accordingly. As such, the modified signature address corresponds to the identified service and/or management function(s). The packet can thereby be appropriately routed to the service function(s) and/or management function(s) having the capacity to handle the traffic, based on balancing the loads between the various functions.

Examples provided herein may be implemented in hardware, software, or a combination of both. Example systems can include a processor and memory resources for executing instructions stored in a tangible non-transitory medium (e.g., volatile memory, non-volatile memory, and/or computer readable media). Non-transitory computer-readable medium can be tangible and have computer-readable instructions stored thereon that are executable by a processor to implement examples according to the present disclosure.

An example system (e.g., including a controller and/or processor of a computing device) can include and/or receive a tangible non-transitory computer-readable medium storing a set of computer-readable instructions (e.g., software, firmware, etc.) to execute the methods described above and below in the claims. For example, a system can execute instructions to direct a system to cause packets to be forwarded based on available capacity of service and/or management functions in the context of MAC chaining, based on any combination of hardware and/or software to execute the instructions described herein. As used herein, the processor can include one or a plurality of processors such as in a parallel processing system. The memory can include memory addressable by the processor for execution of computer readable instructions. The computer readable medium can include volatile and/or non-volatile memory such as a random access memory (“RAM”), magnetic memory such as a hard disk, floppy disk, and/or tape memory, a solid state drive (“SSD”), flash memory, phase change memory, and so on.

What is claimed is:

1. A networking component comprising:
an ingress port to receive a packet including a signature address;
a filter table to be used in Media Access Control (MAC) chaining, to contain mappings between signature addresses, service functions, and management functions, to identify corresponding service function chains;
a load balancer to identify at least one of i) a service function instance among a plurality of service function instances, and ii) a management function instance among a plurality of management function instances, for packet distribution among the plurality of corresponding functions based on an available capacity of the corresponding functions; and
a controller to modify tables of packet signature addresses usable to modify the packet corresponding to the identified at least one of the i) service function and ii) management function, to cause the packet to be forwarded accordingly.

2. The networking component of claim 1, further comprising a port multiplexer to forward the packet.

3. The networking component of claim 2, wherein the port multiplexer is to forward the packet based on MAC chaining, to enable multiplexing at a lowest software stack level.

4. The networking component of claim 1, wherein the filter table, load balancer, and controller are implemented as an application in a guest operating system (OS) of a computing device.

5. The networking component of claim 1, wherein the networking component is based on Direct Memory Access (DMA) for the packet, and is implemented as a virtual machine associated with at least one virtual network interface controller (vNIC).

6. The networking component of claim 5, wherein the controller is to map a virtual port (vport) to a corresponding vNIC.

7. The networking component of claim 6, wherein mappings of the filter table are based on an egress vport, such that the filter table includes mappings for a given packet between i) a key, a vport, and a destination MAC, and ii) a new destination MAC and vport.

8. The networking component of claim 1, wherein the networking component is based on message passing for the packet, and is associated with at least one mailbox serving as a delivery point for messages in the OS core.

9. The networking component of claim 1, wherein the networking component is to prioritize processing MAC chaining headers, corresponding to service functions for the packet, over processing of management headers, corresponding to management functions for the packet.

10. The networking component of claim 9, wherein the networking component is to check the packet for management headers of the packet that follow the MAC chaining headers of the packet.

11. The networking component of claim 1, wherein the filter table is a forwarding database, and wherein the filter table and the load balancer are built using OpenFlow.

12. A method, comprising:
mapping, by a filter table to be used in Media Access Control (MAC) chaining, between signature addresses of a packet, service function chains, and corresponding service functions and management functions;
identifying, by a load balancer, at least one of i) a service function instance among a plurality of service function instances, and ii) a management function instance among a plurality of management function instances, for packet distribution among the plurality of corresponding functions based on an available capacity of the corresponding functions; and
modifying, by a controller, tables of packet signature addresses usable to modify the packet corresponding to the identified at least one of the i) service function and ii) management function, to cause the packet to be forwarded accordingly.

13. The method of claim 12, further comprising forwarding the packet via a port multiplexer.

14. A non-transitory machine-readable storage medium encoded with instructions executable by a computing system that, when executed, cause the computing system to:
map, by a filter table to be used in Media Access Control (MAC) chaining, between signature addresses of a packet, service function chains, and corresponding service functions and management functions;
identify, by a load balancer, at least one of i) a service function instance among a plurality of service function instances, and ii) a management function instance among a plurality of management function instances, for packet distribution among the plurality of corresponding functions based on an available capacity of the corresponding functions; and
modify, by a controller, tables of packet signature addresses usable to modify the packet corresponding to the identified at least one of the i) service function and ii) management function, to cause the packet to be forwarded accordingly.

15. The storage medium of claim 14, further comprising instructions that cause the computing system to forward the packet via a port multiplexer.
